(19) United States
(12) Patent Application Publication
(10) Pub. No.: US 2009/0001846 A1
(43) Pub. Date: Jan. 1, 2009

(54) Electrostatic Surface Drive With Multiple Operating Voltages

(75) Inventors: Mark David Bedillion, Allison Park, PA (US); Patrick Breckow Chu, Wexford, PA (US); Zoran Jandric, Pittsburgh, PA (US)

Correspondence Address: PIETRAGALLO GORDON ALFANO BOSICK & RASPANTI, LLP, ONE OXFORD CENTRE, 38TH FLOOR, 301 GRANT STREET, PITTSBURGH, PA, 15219-6404, US

(73) Assignee: Seagate Technology LLC, Scotts Valley, CA (US)

(21) Appl. No.: 11/769,090

(22) Filed: Jun. 27, 2007

(51) Int. Cl. H02N 1/00

(52) U.S. Cl. 310/309

(57) ABSTRACT

An apparatus includes a first array of electrodes and a second array of electrodes separated by a gap, and a controller for imposing a voltage on a plurality of electrodes in the first array of electrodes, wherein the magnitude of the voltage changes in response to an operating parameter of the apparatus.

### FIELD OF THE INVENTION

The invention relates generally to electrostatic actuators and more particularly to surface drive actuators.

### BACKGROUND OF THE INVENTION

Electrostatic actuators have been used to position optical devices, to operate switches, and to turn small gears. For data storage devices and other applications, actuators that have a relatively large travel, whose positioning can be controlled with great precision, and that operate in response to a low actuation voltage are needed.

Electrostatic actuators are known in which a movable substrate or “rotor” is moved relative to a fixed substrate or “stator.” The stator can have several sets of electrodes on its surface, some of which are held at a voltage different from ground in order to position the rotor. Stepped motion and continuous motion can be provided by applying a voltage to stator and rotor electrode arrays having different electrode spacing, or pitch.

By applying a voltage to the electrodes, an in-plane force is created to move the rotor relative to the stator. However, the in-plane force is accompanied by an out-of-plane force perpendicular to the plane of the rotor. The out-of-plane force attracts the rotor towards the stator and can be significantly greater than the in-plane force. In the presence of an external disturbance, a large out-of-plane force contributes to a total force on the rotor that may cause instability where the gap between rotor and stator diminishes to zero. This is commonly known as snap-down for electrostatic actuators.

In a data storage device, where a suspension assembly is used to maintain the spacing between the rotor and stator, the large attractive out-of-plane force places significant constraints on the suspension. Spring members in the form of folded beam flexures can be used in micromachined devices to position the rotor with respect to the stator. If the ratio of the out-of-plane force to the in-plane force were large, then the spring members would need a large thickness in the out-of-plane direction in comparison to the in-plane width of the same spring members, to have sufficiently higher out-of-plane stiffness than in-plane stiffness. Such a structure, with high aspect ratio of the spring members, is difficult to fabricate using conventional processing.

There is a need for an electrostatic actuator and a method for controlling an electrostatic actuator that provides precise positioning of a rotor in a plane without subjecting the rotor to excessive out-of-plane force.

### SUMMARY OF THE INVENTION

In a first aspect, the invention provides an apparatus including a first array of electrodes, a second array of electrodes, wherein the first and second arrays of electrodes are separated by a gap, and a controller for imposing a voltage on a plurality of electrodes in the first array of electrodes, wherein the magnitude of the voltage changes in response to an operating parameter of the apparatus.

The operating parameter can be, for example, the relative position of the first and second arrays of electrodes, a force to be exerted on the second arrays of electrodes, or a phase state of the apparatus. The voltage can be selected from a continuum of voltages. Additional arrays of electrodes can be included.

In another aspect, the invention provides a method, comprising: providing a first array of electrodes and a second array of electrodes, wherein the first and second arrays of electrodes are separated by a gap, and imposing a voltage on a plurality of electrodes in the first array of electrodes, wherein the magnitude of the voltage changes in response to an operating parameter of an apparatus including the first and second arrays of electrodes.

### BRIEF DESCRIPTION OF THE DRAWINGS

FIG. 1 is a schematic representation of a data storage device including an actuator constructed in accordance with an aspect of the invention.

FIG. 2 is a schematic representation of an electrostatic actuator and a controller.

FIGS. 3a, 3b, 3c, 3d, 3e and 3f are schematic diagrams that illustrate the operation of an electrostatic actuator.

FIG. 4 is a graph of the normalized forces applied to the rotor shown in FIG. 2 as a function of the rotor pitch/gap ratio.

FIG. 5 is a graph of the normalized forces applied to the rotor shown in FIG. 2 as a function of the rotor position.

FIG. 6 is a graph of in-plane and out-of-plane forces as a function of the rotor position.

FIG. 7 is a graph of gap spacing as a function of the rotor position.

FIG. 8 is a graph of in-plane force as a function of the motor phase.

FIG. 9 is a graph of in-plane and out-of-plane forces as a function of the motor phase.

FIG. 10 is a graph of gap spacing as a function of the motor phase.

FIG. 11 is a block diagram of an actuator control system.

FIG. 12 is a graph of rotor position versus time.

FIG. 13 is a graph of applied voltage versus time.

FIG. 14 is a graph of applied voltage versus time.

### DETAILED DESCRIPTION OF THE INVENTION

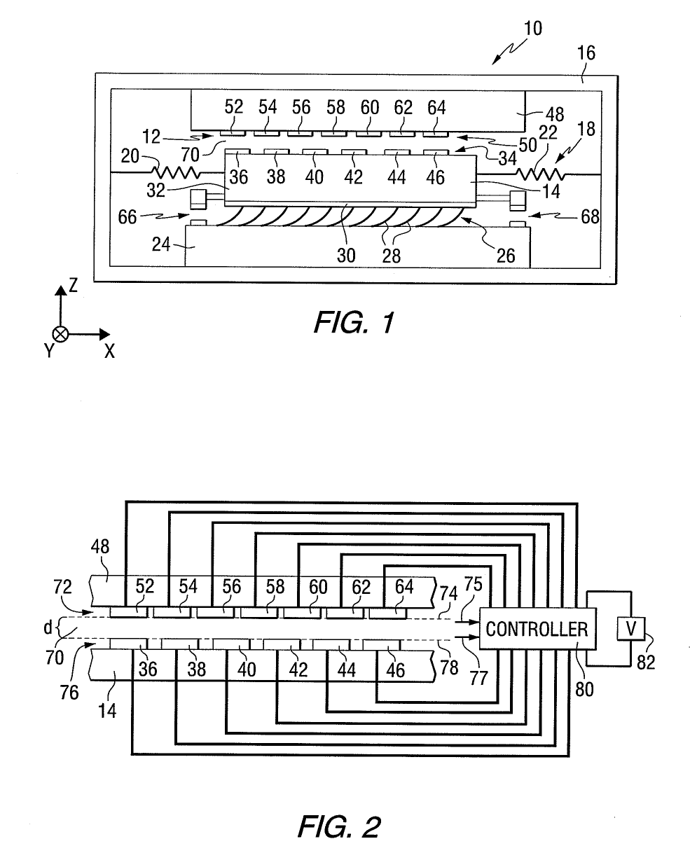

Referring to the drawings, FIG. 1 is a schematic representation of a data storage device 10 including an actuator 12 constructed in accordance with an aspect of the invention. The data storage device includes a movable member 14, also referred to as a sled, which is supported in an enclosure or frame 16 by a suspension assembly 18. The suspension assembly can include a plurality of spring or beam members 20 and 22 that are structured and arranged to allow movement of the sled in an X-Y plane. In one example, the spring members have a rectangular cross-sectional shape, and a larger dimension in the Z-direction than in either the X or Y-direction. This limits motion of the sled in the Z-direction.

The data storage device of FIG. 1 includes a three wafer stack. The bottom wafer 24, also called the head wafer, contains an array 26 of transducers 28, also called probes, tips or electrodes. Ends of the transducers are positioned adjacent to, or in contact with, a storage medium 30, mounted on a middle wafer 32. The bottom wafer can also include electric circuits such as preamp electronics.

The middle wafer 32 supports a rotor 34 of the electrostatic actuator and also the data storage medium that interacts with the transducer array. The rotor includes a plurality of electrodes 36, 38, 40, 42, 44 and 46 that are arranged in a first linear array in a plane along a surface of the middle wafer. The electrodes can be evenly spaced and can have a rectangular cross-section. The electrodes extend in a direction perpendicular to the plane of the drawing.

The top wafer 48 supports a stator 50 of the electrostatic actuator. The stator includes a plurality of electrodes 52, 54, 56, 58, 60, 62 and 64 that are arranged in a second linear array in a plane along a surface of the top wafer. The electrodes can be evenly spaced and can have a rectangular cross-section. The electrodes extend in a direction perpendicular to the plane of the drawing. The electrodes of the rotor and stator are separated by a gap 70.

The rotor on the middle wafer is suspended between the top and bottom wafers by the suspension assembly 18, 20 that is significantly more compliant in the X-Y plane (i.e., the in-plane direction) than in the Z-direction (i.e., the out-of-plane direction).

A controller, not shown in this view, is used to supply voltages to the electrodes of the first and second arrays. One or more sensors 66, 68 can be included to provide information to the controller concerning the relative positions of the rotor and stator. Then the controller can use the position information to adjust the voltages supplied to the actuator electrodes, and thereby control relative movement between the stator and the rotor. The sensors can be, for example, capacitive sensors, strain gauges, optical encoders, or magnetic encoders.

While the invention will be described in terms of a data storage device, it can also apply to other devices requiring relative movement between two members, which can be connected to a stator and a rotor.

FIG. 2 is a schematic representation of an electrostatic actuator and a controller. The elements of the electrostatic actuator 12 of FIG. 1 are shown schematically in FIG. 2. The electrostatic actuator includes a first linear array 72 of electrodes 52, 54, 56, 58, 60, 62 and 64 disposed in a first plane 74 and positioned on a stator 48, and a second linear array 76 of electrodes 36, 38, 40, 42, 44 and 46 disposed in a second plane 78 and positioned on a rotor 14. The first linear array of electrodes is referred to as the stator or drive electrodes, and the second array of electrodes is referred to as the rotor or driven electrodes. The stator electrodes and the rotor electrodes are separated by a gap 70 of a distance d. The first and second planes are substantially parallel to each other. FIG. 2 shows an end view of the stator electrodes and the rotor electrodes, which are each elongated in a plane perpendicular to the plane of the drawing. The electrodes can have a rectangular cross-sectional shape.

A controller 80 is electrically connected to the electrodes. A voltage source 82 supplies a voltage to the controller. The controller can receive signals, for example on lines 75 and 77, that are representative of the relative positions of the stator and rotor. Voltages at several levels, or magnitudes can be applied to the electrodes by the controller to establish a changing voltage pattern along at least one of the arrays of electrodes. In this invention, the controller applies voltages at several levels (i.e., magnitudes) to the electrodes to effect relative movement between the rotor and the stator, while mitigating out-of-plane forces on the rotor. The voltage to be applied can be determined based on various operating parameters or characteristics of the actuator, such as the distance between the electrode arrays, the distance between a rotor and stator that support the electrode arrays, the force to be exerted on the rotor, the phase state of the actuator, etc. As used in this description, the phase state represents the phase of the sinusoidal in-plane force vs. position curve, which depends on the applied voltage vector. Once a desired voltage level is determined, that voltage level can be applied to a plurality of the drive electrodes. Alternatively, different voltage levels can be applied to different drive electrodes simultaneously.

The example shown in FIG. 2 illustrates only the single array of stator electrodes and the single array of rotor electrodes. To multiply the in-plane force exerted on the rotor, a plurality of arrays of rotor electrodes similar to the rotor electrode array or FIG. 2 can be positioned across the surface of the rotor, and a plurality of arrays of stator electrodes similar to the stator electrode array of FIG. 2 can be positioned across the opposed surface of the stator. Thus, in one example, multiple groups of six rotor electrodes and seven stator electrodes can be positioned along the surfaces of the rotor and stator, respectively. Adjacent arrays may be spaced from one another by a spacing equal to the pitch of the electrodes in the arrays themselves to maintain a constant pitch along the length of the arrays. As used herein, the pitch is the distance between a point of one of the electrodes and a corresponding point on an adjacent electrode.

The rotor can be supported by a suspension assembly including spring members in the form of folded beam flexures connected between the rotor and a support structure, such as a housing, case or enclosure. The housing, case or enclosure can be connected to the stator. The folded beam flexures would be compliant in the X and Y-directions but stiff in the Z-direction. The compliance of the folded beam flexures in the X and Y-directions allows the rotor to move more readily in the X-Y plane. The stiffness of the folded beam flexures in the Z-direction prevents collapsing of the rotor onto the stator, due to the out-of-plane force exerted on the rotor.

To reduce the out-of-plane force for a given in-plane force, the pitch/spacing ratio p/d, which is the ratio between the electrode pitch p of the rotor and the spacing d between the stator and rotor electrode arrays can be adjusted. The out-of-plane force is minimized for a given in-plane force when the pitch/spacing ratio is less than about 2.25. In one example, the pitch/spacing ratio is 1.5.

In-plane motion can be provided by an array of electrodes located on the rotor, referred to as the driven array, and a corresponding array of electrodes located on the stator, referred to as the drive array. In operation, the drive electrodes can be subjected to a disrupted voltage pattern while an alternating voltage pattern on the driven electrodes remains unchanged. In one example, each driven array has an even number nᵣ of rotor electrodes and each drive array has an odd number nₛ of stator electrodes, so that nₛ=nᵣ±1. The ratio of the pitch of the driven electrodes to the pitch of the drive electrodes is nᵣ/nₛ.

The drive electrodes may alternatively be located on the rotor, in which case, the driven electrodes would be located on the stator. The ratio of the pitch of the rotor electrodes to the pitch of the stator electrodes is equal to the ratio of the number of stator electrodes and the number of rotor electrodes.

The electrostatic actuator shown in FIG. 2 can operate as a stepping motor. The stable in-plane position of the rotor can be changed by creating a local disruption in the voltage pattern applied to the array of electrodes on either the rotor or the stator. The alternating voltage pattern applied to the other array of electrodes can remain unchanged. The electrostatic actuator may also operate as a servo motor using feedback control.

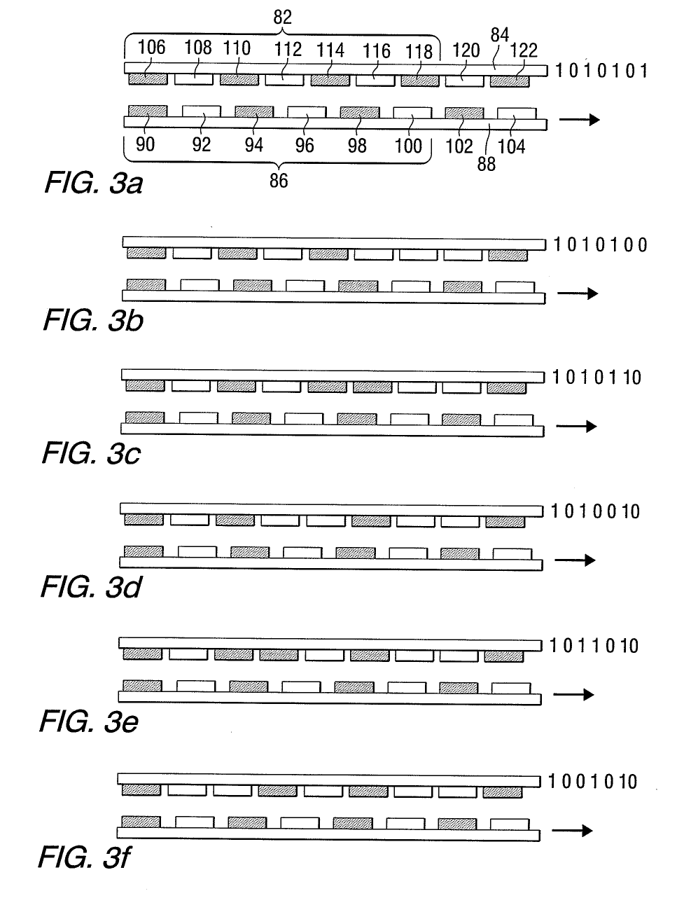

In a data storage application, actuators must provide high-precision motion, fast seek times, and mechanical rigidity. FIGS. 3a through 3f are schematic representations of the electrodes of an electrostatic surface drive actuator. FIGS. 3a through 3f illustrate the electrostatic stepper motor concept. The electrostatic surface drive actuator includes two wafers on which electrodes are deposited and which are kept in close proximity by a suspension (not shown). In this example, a group 82 of stator electrodes is positioned on a stator 84, and a group 86 of rotor electrodes is positioned on a rotor 88. A set of voltages, having magnitudes of either V or 0, are applied to the rotor electrodes. In FIGS. 3a through 3f, the electrodes receiving the V voltage are shaded, and the electrodes receiving the 0 voltage are not shaded.

FIG. 3a shows that a voltage of V is applied to alternate electrodes of the stator and rotor to produce an alternating voltage pattern on the electrode arrays located on each of the stator and the rotor. The voltage applied to the stator electrodes alternates between the first voltage (V) and the second voltage (0), where the first voltage is applied to the first electrode in the stator array. More particularly, in FIG. 3a, electrodes 90, 94, 98 and 102 receive the V voltage, and electrodes 92, 96, 100 and 104 receive the 0 voltage. Thus V is applied to alternate rotor electrodes. Voltages of V or 0 are similarly applied to the stator electrodes 106, 108, 110, 112, 114, 116, 118, 120 and 122. More particularly, electrodes 106, 110, 114, 118 and 122 receive the V voltage, and electrodes 108, 112, 116 and 120 receive the 0 voltage. The numbers to the right of the stators are a binary representation of the voltages applied to the stator electrodes, with “1” representing V and “0” representing 0 volts.

The stator electrodes have a set of voltage levels that change periodically in groups of n electrodes. For example, n−1 of the n stator electrodes can each have voltage value of either V or 0. To provide a small (i.e., microstep) movement of the rotor, the remaining stator electrode can have an analog voltage with a value, or magnitude, between 0 to V. The voltage pattern on the n stator electrodes determines the in-plane equilibrium position of the rotor relative to the stator. In one example, nₛ=7 for the stator electrodes and nᵣ=6 for the rotor electrodes. FIGS. 3b through 3f show how the voltages can be changed on the stator electrodes to produce a force that moves the rotor in the direction indicated by the arrows.

In-plane movement of the rotor is induced by locally disrupting the initial alternating voltage pattern by switching the voltage on one electrode of the stator array from one voltage level to the other voltage level, as shown in FIGS. 3b through 3f.

Alternative actuation patterns may also be applied in a bipolar implementation using +V or −V, rather than V or 0 in order to optimize actuator efficiency and in-plane/out-of-plane force ratio.

The in-plane position of the rotor can be progressively stepped without changing the alternating voltage pattern imposed on the rotor electrodes. As a result, the stepping rate is not limited by the dynamic electrical characteristics of the rotor. Moreover, only one stator electrode in each set of stator electrodes need be switched at any one time, to step the rotor position. This imposes a minimum of timing constraints on the stator voltage control circuitry.

Because the voltage pattern on the rotor does not need to change with time, the electrostatic actuator according to the invention may also operate when the alternating voltage pattern is established on the rotor opposed surface in some other way. For example, the alternating voltage pattern may be established by electrostatic charge deposited on the opposed surface, by a poled ferroelectric material located on the opposed surface, or by a strain field established in a piezoelectric material located on the opposed surface.

In another example, one half of the electrodes in the rotor array may be replaced by a conductive plane set to a predetermined voltage, such as ground potential. This conductive plane forms “effective” electrodes between adjacent physical electrodes. For example, a conductive plane may be formed, and may be covered by an insulating layer on which a linear array of electrically-interconnected physical electrodes is located. Each region of the conductive plane between adjacent physical electrodes functions as an effective electrode. The voltage pattern is established by setting the electrically-interconnected physical electrodes to a voltage different from that of the conductive plane.

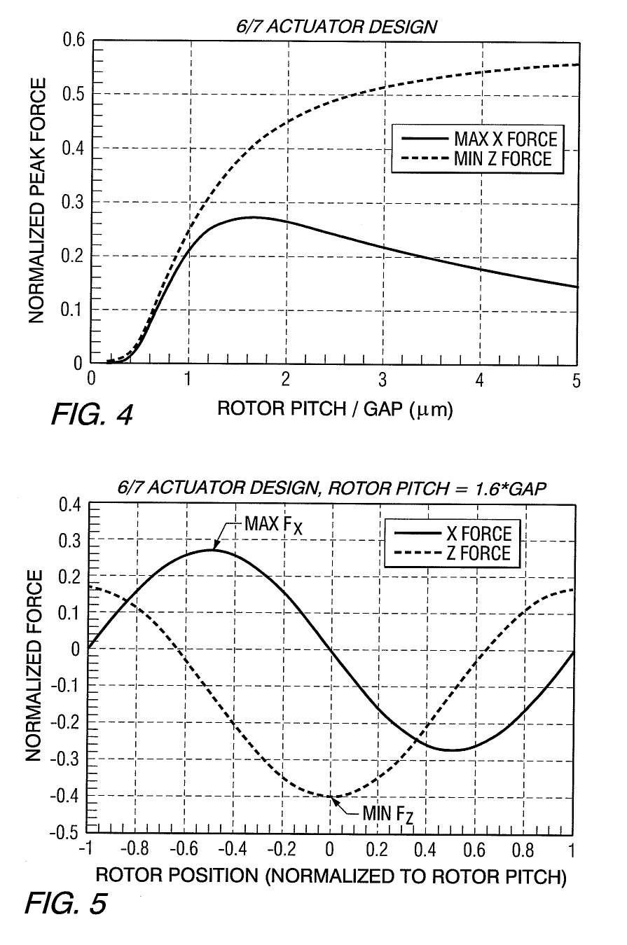

FIG. 4 shows the relationship between the in-plane and out-of-plane forces and the ratio of the rotor electrode pitch to the gap spacing. Note that the out-of-plane force magnitude (i.e., the force in the Z-direction) is larger than the in-plane force magnitude, which means that high aspect ratio springs must be used in the suspension assembly to achieve sufficient in-plane force while preventing actuator collapse out-of-plane. Higher aspect ratio springs are more expensive and more difficult to manufacture.

The relationship between in-plane and out-of-plane forces creates a fundamental limitation on the performance of electrostatic surface drive actuators, and requires high voltages to achieve the sufficient in-plane forces. These high voltages may be costly to produce from a power and electronics perspective.

FIG. 5 shows the sinusoidal nature of the electrostatic forces with respect to rotor position. In the absence of a suspension, the rotor tends to locate at the stable equilibrium point of the in-plane curve, which occurs at position 0 in FIG. 5. Changing the pitch of the electrode pattern on the stator shifts the phase of the in-plane curve and hence the position of the stable in-plane equilibrium. Note that the highest magnitude Z-force in FIG. 5 also occurs at the 0 position. This implies that without a suspension, the Z-force will always act with the highest magnitude when the actuator is at a stable position, which is the least favorable condition.

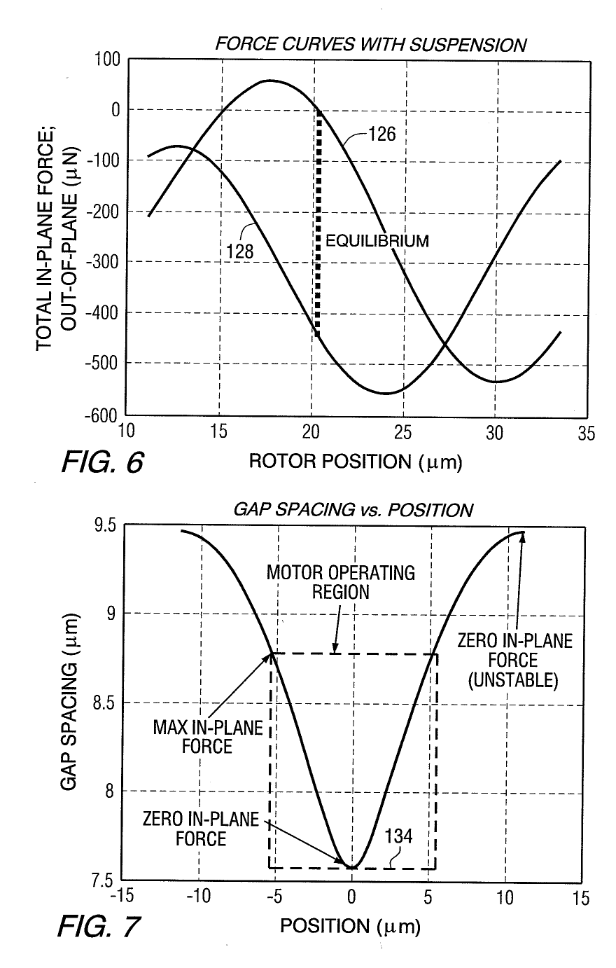

However, when a suspension is included in the analysis, the suspension force acts against the electrostatic force and accordingly shifts the equilibrium position so that the Z-force will no longer have its highest magnitude at equilibrium, as shown in FIG. 6. FIG. 6 is a graph of in-plane 126 and out-of-plane 128 forces as a function of rotor position with a suspension force included in the analysis and the rotor positioned in such a way from the spring equilibrium, where the net in-plane force is zero. The combination of the actuator force and spring force defines the in-plane equilibrium position. When the spring force is involved, the equilibrium phase of the electrostatic actuator is changed to a point in which the magnitude of the out-of-plane force is no longer maximized at the equilibrium point.

FIG. 7 is a graph of gap spacing versus position. For the purpose of interpreting the graph of FIG. 7, the zero position is the equilibrium position, and the distances on either side of zero represent movement away from the equilibrium position. The force in the in-plane direction in the X axis direction Fₓ is approximately given by

$${F}_{x} = - {F}_{{x}_{max}} sin ( \frac{π}{{p}_{r}} x + φ )$$

where p is the rotor pitch and φ is the phase angle. The phase angle is representative of the amount of linear displacement of the rotor electrode array with respect to the distance defined by twice the rotor pitch. Therefore, the in-plane force is sinusoidal in the in-plane direction with amplitude Fₓ_{ₘₐₓ} and period 2p.

Similarly, the force in the Z-direction is approximately given by

$${F}_{z} = - {F}_{{z}_{max}} cos ( \frac{π}{{p}_{r}} x + φ ) - {F}_{{z}_{avg}}$$

where F_{z}_{_{avg}} is a static offset. From these expressions the relationship between position and phase becomes apparent. In the example of FIG. 7, the rotor pitch is approximately 11 μm, so the plot shows ±1 rotor pitch in the X-direction.

The plot of FIG. 7 shows one full cycle of the periodic force. It is desirable to operate only in the portion of the curve in which the force is stable. The equilibrium point at x=0 is stable, whereas the equilibrium points at x=±p are unstable (±11 on the plot). Stability therefore occurs between the maximum force values, which occur at ±90° in the phase space. Thus the actuator is intended to operate within the phases bounded by the box over a phase range bounded by ±90°. The maximum/minimum force occurs where x=±p/2, and the reduced gap at the phases with maximum in-plane force limits the achievable actuation force.

Thus it can be seen that electrostatic surface drives have a fundamental force limitation caused by a large parasitic out-of-plane force. The out-of-plane force tends to collapse the actuator rotor and stator into each other. Thus, the performance of the actuator is limited by the aspect ratio of the suspension springs and the voltage available to the system. It is more expensive and challenging to make very high aspect ratio springs (e.g., with an aspect ratio >40) and costly to use high voltages (e.g., >80 volts). High voltage also leads to high actuator power consumption. It would be desirable to reduce the voltage level applied to the electrodes and to reduce the spring aspect ratio while achieving high force and large stroke.

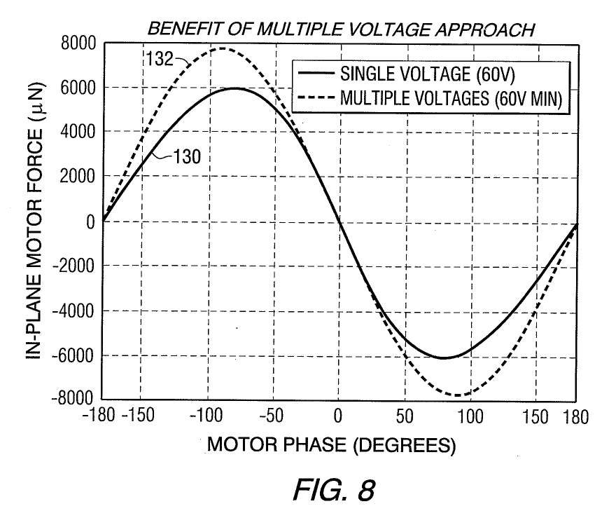

FIG. 8 is a graph showing the benefit of the multiple voltage level approach. Curve 130 shows the in-plane actuator force as a function of motor phase with the gap changing as shown in FIG. 7.

Curve 132 shows the in-plane actuator force with the gap fixed to be the minimum gap of FIG. 7. The method of this invention changes the voltage to reduce the change in operating gap with the motor phase. If a continuum of operating voltages is available, curve 132 is achievable. However, a benefit can also be obtained by switching between discrete operating voltages.

In previously known actuators, n−1 of the n stator electrodes each have voltage value either V or 0. To produce a microstep, the remaining stator electrode can have an analog voltage with a value between 0 and V. In this invention, the n−1 of the n stator electrodes each may have voltage value of either 0 or Vᵢ, where Vᵢ is selected from a set of voltages V={+V₁ . . . +V_{M}} etc., where M is the (possibly infinite) number of possible operating voltages. In an ideal implementation, the voltage variation would be continuous, i.e., M→∞. However, for a practical implementation, a finite number of voltages may be used. All non-zero stator electrodes get the new voltage Vᵢ except for the microstepped electrode, which takes on a value between 0 and Vᵢ. The microstepped electrode is used to make finer steps than those given by the full steps. The full steps are of size p/n, where n is the number of stator electrodes.

In one aspect, the method of this invention seeks to keep the gap constant with respect to motor phase. A constant gap corresponds to a horizontal line 134 in FIG. 7 that intersects the minimum of the gap curve. The potential in-plane force gain of using this approach is shown in FIG. 8. Both curves in FIG. 8 operate at the same gap at zero motor phase. For curve 132, the gap is held constant, whereas for curve 130 the gap is allowed to change as with previously known actuators. FIG. 8 shows a substantial force benefit provided by this invention compared to prior art.

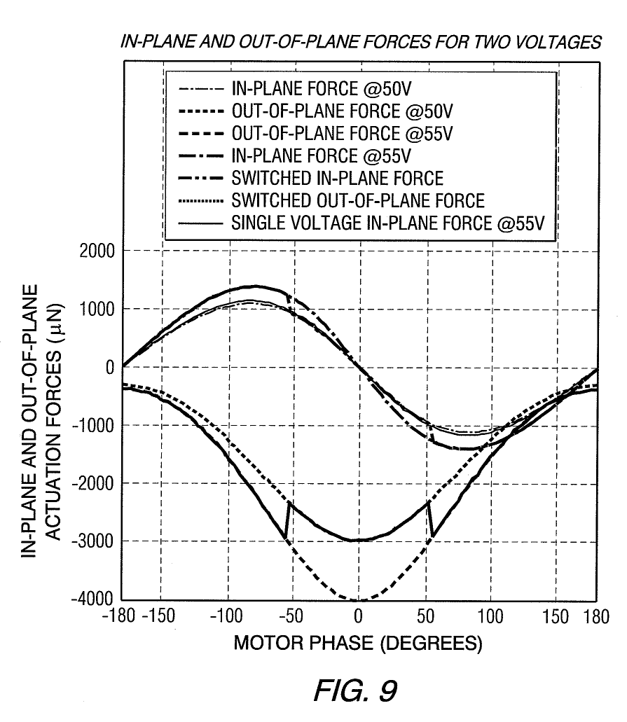

FIG. 9 is a graph of in-plane and out-of-plane actuation forces versus motor phase for a switched voltage scheme using two voltages. The maximum force is increased by 26% versus using 50 V alone and 21% versus using 55 V alone without sacrificing stability margin. The switching points, shown at about ±55° in this example, can be selected based on the force desired by the feedback controller.

FIG. 9 illustrates an approach when two non-zero voltages are present in the system, i.e., M=2. One voltage in the system can be chosen such that the minimum Z-force does not cause the actuator to collapse, while the other voltages in the system may produce minimum Z-forces that could cause actuator collapse.

Switching between actuator voltages is performed in such a way that the actuator does not collapse. In FIG. 9, switching between the two non-zero voltages does not occur until the equilibrium motor phase is sufficiently far from zero so that the higher voltage Z-force does not collapse the actuator. A “0” phase means 0 in-plane motor force and minimum out-of-plane motor force.

The available actuation force is much greater for the second voltage than it is for the first voltage. By switching among multiple voltages in this fashion, higher voltages may be used at smaller gaps than would otherwise be possible, which generates substantially more force.

It is clear from FIG. 9 that the maximum in-plane force when using the switched voltage approach is substantially higher than the available force when using the maximum voltage alone for a given stability margin.

The invention improves the actuator performance for a given voltage limit and suspension spring aspect ratio. This performance improvement allows the designer to use lower voltages or spring aspect ratios to reach a desired performance specification. In either case, the cost of the device may decrease. This performance increase is achieved without changing device fabrication techniques and without any substantial changes to architecture.

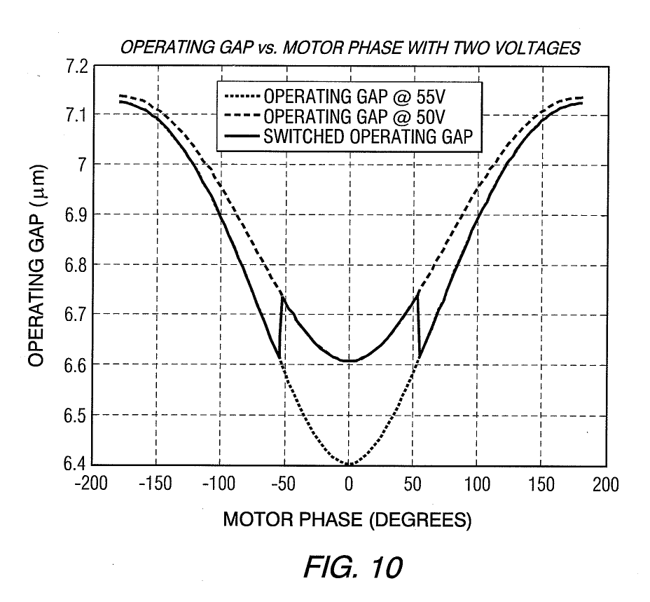

FIG. 10 is a graph of operating gap versus actuator phase showing a switched operating gap. The gap in the operating region (±90°) has substantially less variation for the design with two voltages. More voltages and multiple switches can be used to further decrease the gap variation across the actuator phase. In the ideal case with a continuum of voltages, the gap would be held constant at the minimum gap for a 50 V operating voltage.

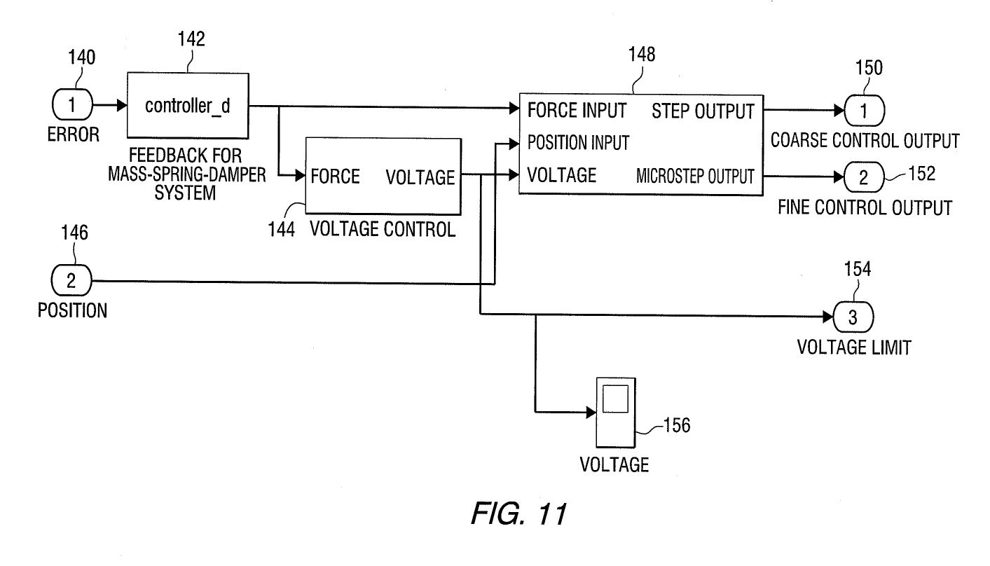

To demonstrate the benefits of the multi-voltage actuator control approach, a simulation model has been developed that considers actuator performance with coupling between in-plane and out-of-plane forces. A schematic diagram of a control system for the multiple voltage implementation is shown in FIG. 11. In the electrostatic actuator controller of FIG. 11, the error signal 140 is fed into a linear feedback controller 142 to determine the desired force. The desired force is used to select from a set of voltages as illustrated by voltage control 144. A continuum of voltages may be used for better performance. A position signal 146 is received from position sensors in the device. The voltage, the desired force, and the current actuator position are then used to determine the voltage pattern that is applied to the stator electrodes, as illustrated by a linearization circuit 148. The linearization circuit produces control signals in the form of a coarse control output 150 and a fine control output 152. The voltage limit 154 can be monitored as shown by voltmeter 156.

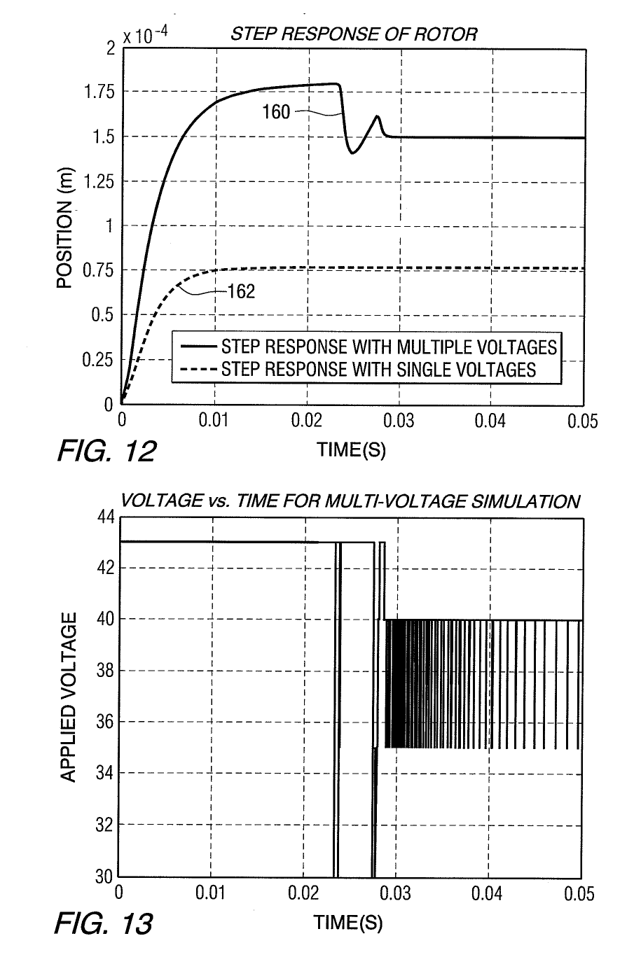

In the example of FIG. 11, the output from the controller 142 is used to select the actuator operating voltage. This operating voltage would then be used within the linearization block to determine the appropriate voltage pattern to apply to the stator electrodes. FIG. 12 shows an actuator performance simulation with and without multiple voltages for a given starting gap with and without the multiple voltage scheme applied.

Switching between the actuator voltages may be chosen based on the force desired by the actuator's feedback controller. The force requested by the feedback controller determines which phase the actuator will be in, which in turn defines the minimum Z-force that will be seen in the system. There exists a relationship between the applied voltage and the Z-force curve, which may then be used to determine when switching is feasible and beneficial. For example, the in-plane and out-of-plane forces may be calculated a priori via a model and then used in the final device.

In FIG. 12, the desired output is 150 μm of displacement. The use of multiple voltages achieves the desired position as illustrated by curve 160, while the response with a single voltage is unable to overcome the spring force, as shown by curve 162. The two designs have the same performance for positions near 0 μm. A single voltage larger than the maximum voltage used in this simulation would be needed to achieve the desired stroke with a single voltage. For this simulation, the controller performance has not been optimized, and a substantially smoother, faster response would be possible with an improved voltage switching algorithm. The simulation of FIG. 12 illustrates a proof of concept.

The multiple voltage scheme increases the available force as the actuator is operated at phases far from zero, which allows the rotor to reach its desired position. FIG. 13 is a graph of voltage versus time for the multiple voltage approach. The starting voltage is high because the controller attempts to move the rotor to its final position as quickly as possible. As the rotor approaches its final position, the voltage is switched to a lower value because the controller does not demand as much force. The chattering of the voltage in steady state may be eliminated with a more sophisticated voltage control. FIG. 13 is simply intended to be a proof of concept.

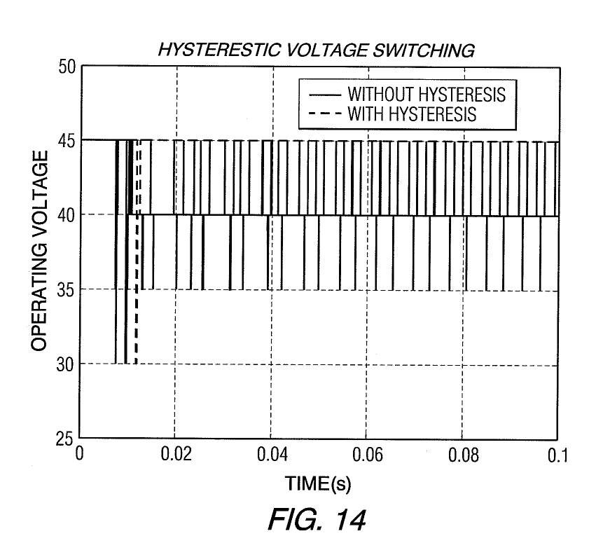

FIG. 13 shows the voltage profile used in the simulation. A simple selection control based on a required force threshold is used for this simulation. It is clear that with a simple selection control, voltage chattering occurs. A more sophisticated voltage control algorithm can eliminate this chattering. A hysteretic voltage scheme, for example, may be used to eliminate this chattering effect. The voltage switching with this approach applied is shown in FIG. 14. The hysteresis may be described by the following pseudocode:

```
if force>lim2
  V=V2;
elseif force<lim1−ep
  V=V0;
elseif force<lim2−ep & force>lim1
  V=V1;
end,
```

which is limited to two states for clarity. The hysteretic switching rule also applies to any number of states m. The value ep in the pseudocode is the hysteresis parameter that determines when switching occurs along with the defined switching limits. For instance, in the pseudocode example, if the force transitions from a value less than lim1 to a value greater than lim1, the state can change from V=V0 to V=V1. If the force then moves below lim1 the state does not change back to V=V0 until the force moves below lim1−ep. This prevents rapid chattering of the voltage signal.

The multiple voltage approach gives a larger force for a given maximum voltage. For example, given a 50 V voltage limit, the multiple voltage approach gives a maximum in-plane force of 3.2 mN, compared to 2.6 mN when using 50 V as the only voltage applied to the actuator. This achieves a 23% improvement in available force. With this approach, the available force at 0 phase is less than that available for the single voltage case. However, no force is required to overcome the spring force at 0 phase, and hence it is natural that less force should be required there.

This invention provides a method of improving the force performance of electrostatic surface drives by using multiple operating voltages. The method switches between the multiple operating voltages based on the desired actuation force. The desired operating force can be obtained with a feedback controller, and the operating voltage can be used in conjunction with the desired force to generate a pattern for the stator voltages. In one example, a continuum of operating voltages can be used.

The method mitigates the risk of rotor collapsing by switching the voltage, thus allowing the device to operate at significantly higher voltages at smaller gaps while maintaining stability. The method can be applied to actuators that include various electrode configurations. For example, the ratio of the number of drive electrodes to the number of driven electrodes in each group can be 6/7, 2/7, 3/8, etc., as long as there is a phase difference between the in-plane and out-of-plane forces.

Although the invention has been described in terms of several examples, it is to be understood that the invention is not limited to the described examples, and that various modifications may be practiced within the scope of the invention defined by the appended claims.

What is claimed is:

1. An apparatus, comprising:
a first array of electrodes;
a second array of electrodes, wherein the first and second arrays of electrodes are separated by a gap; and
a controller for imposing a voltage on a plurality of electrodes in the first array of electrodes, wherein the magnitude of the voltage changes in response to an operating parameter of the apparatus.

2. The apparatus of claim 1, wherein the operating parameter is the relative position of the first and second arrays of electrodes.

3. The apparatus of claim 2, wherein the first array of electrodes lies in a first plane and the relative position is measured in a direction substantially perpendicular to the first plane.

4. The apparatus of claim 1, wherein the operating parameter is a force to be exerted on the second array of electrodes.

5. The apparatus of claim 1, wherein the operating parameter is a phase state of the apparatus.

6. The apparatus of claim 1, wherein the first array of electrodes is positioned in the first plane, and the second array of electrodes is positioned in a second plane substantially parallel to the first plane, and the apparatus further comprises:
additional arrays of electrodes in the first plane; and
additional arrays of electrodes in the second plane.

7. The apparatus of claim 1, wherein the voltage is selected from a continuum of voltages.

8. The apparatus of claim 1, wherein the voltage is applied using a hysteretic voltage scheme.

9. A method, comprising:
providing a first array of electrodes and a second array of electrodes, wherein the first and second arrays of electrodes are separated by a gap; and
imposing a voltage on a plurality of electrodes in the first array of electrodes, wherein the magnitude of the voltage changes in response to an operating parameter of an apparatus including the first and second arrays of electrodes.

10. The method of claim 9, wherein the operating parameter is the relative position of the first and second arrays of electrodes.

11. The method of claim 10, wherein the first array of electrodes lies in a first plane and the relative position is measured in a direction substantially perpendicular to the first plane.

12. The method of claim 9, wherein the operating parameter is a force to be exerted on the second array of electrodes.

13. The method of claim 9, wherein the operating parameter is a phase state of the apparatus.

14. The method of claim 9, wherein the first array of electrodes is positioned in the first plane, and the second array of electrodes is positioned in a second plane substantially parallel to the first plane, and the apparatus further comprises:
additional arrays of electrodes in the first plane; and
additional arrays of electrodes in the second plane.

15. The method of claim 9, wherein the voltage is selected from a continuum of voltages.

16. The method of claim 9, wherein the voltage is applied using a hysteretic voltage scheme.
